(19) United States
(12) Patent Application Publication
(10) Pub. No.: US 2023/0072370 A1
(43) Pub. Date: Mar. 9, 2023

(54) PROTEIN EXTRACT COMPOSITIONS WITH SUPRAMOLECULAR STRUCTURES FOR AGRICULTURAL USE

(71) Applicant: BPS JUST ENERGY TECHNOLOGY, LLC, Argyle, TX (US)

(72) Inventors: Robert A. GEIGER, Argyle, TX (US); Donna Jean SHOTWELL, Argyle, TX (US); Jason L. HURST, Argyle, TX (US); David J. COORTS, Argyle, TX (US)

(21) Appl. No.: 17/799,040

(22) PCT Filed: Oct. 21, 2020
(86) PCT No.: PCT/US2020/056688

§ 371 Date: Aug. 11, 2022

Related U.S. Application Data
(60) Provisional application No. 62/976,136, filed on Feb. 13, 2020.

(51) Int. Cl. C05F 11/00

(52) U.S. Cl. CPC C05F 11/00

(57) ABSTRACT

Compositions with supramolecular structures for agricultural use include a biological compound, a surfactant, a supramolecular host chemical or a supramolecular guest chemical configured to engage in host-guest chemistry with the biological compound, the surfactant, or both, and a solvent. Methods of treating a plant to improve nutrient assimilation, water uptake, yield, shelf life, or vigor include applying an agriculturally effective amount of the composition to the plant.

### BACKGROUND OF THE DISCLOSURE

Carbon, hydrogen, oxygen, nitrogen, phosphorus, and sulfur are the primary elements essential to all life. Soils contain these elements as well as other macro and micronutrients that are needed for plant growth, but due to various reasons the needed nutrients can become unavailable and have minimal uptake causing decrease in plant vigor. To overcome these challenges, various growing techniques have been employed, including slow-release fertilizers, acidifiers, different biostimulants, various growth promoting agents, plant growth adjustment agents, or physiological activity promoting agents.

Over the last few decades there has been growing interest in the agricultural industry to use naturally occurring materials or extractions to create different biostimulants, various growth promoting agents, plant growth adjustment agents, or physiological activity promoting agents. This area has been limited due to the cost of production or application type efficiency, or both.

Thus, compositions and methods have been developed and disclosed below that overcome different and difficult agricultural growing situations, while increasing nutrient use efficiency with the minimal amount of active ingredient used to minimize environmental pollution.

### SUMMARY OF THE DISCLOSURE

In one aspect, the disclosure encompasses an agricultural composition that includes a biological compound (e.g., a plant-derived protein hydrolysate), a surfactant, a supramolecular host or guest chemical configured to engage in host-guest chemistry with the biological compound, the surfactant, or both, and a solvent (e.g., water). In one embodiment, the plant-derived protein hydrolysate includes a protein extract. In a preferred embodiment, the biological compound is a protein extract such as a yeast. Exemplary yeasts exemplary yeasts include the genus Saccharomyces.

The disclosure also encompasses a method that includes preparing the agricultural composition that includes mixing components of the composition in the following order: (1) the solvent, (2) the biological compound, and (3) the surfactant, to form a mixture, and adding (4) the supramolecular host or guest chemical to mixture to form the composition. Solvent (1) may be a polar solvent in one embodiment. In varying embodiments, the composition is applied at a concentration of 0.1 mL to 2 mL of the composition per gallon of carrier fluid or 90 mL to 150 mL of the composition per gallon of carrier fluid.

The disclosure further encompasses a method of treating a plant to improve nutrient assimilation, water uptake, yield, shelf life, or vigor, that includes applying a composition to the plant in an agriculturally effective amount, wherein the composition includes a biological compound, a surfactant, a supramolecular host or guest chemical configured to engage in host-guest chemistry with the biological compound, the surfactant, or both, and a solvent.

### BRIEF DESCRIPTION OF THE DRAWINGS

The present disclosure is best understood from the following detailed description when read with the accompanying figures.

FIG. 1 is a graph showing the increase in plant biomass in pansy of Example 2;

FIG. 2 is graph showing the increase in nutrition assimilation in pansy of Example 2;

FIG. 3 is a graph showing the percent protein change for the composition control in Example 3;

FIG. 4 is a graph showing the percent protein change for the composition in Example 3;

FIG. 5 is a graph showing the increased tissue mass in lettuce of Example 4;

FIG. 6 is a graph showing the increased root mass in lettuce of Example 4;

FIG. 7 is a graph showing the increase of micro/macro nutrients in lettuce of Example 4;

FIG. 8 is a graph showing the increased tissue mass in parsley of Example 5;

FIG. 9 is a graph showing the increased root mass in parsley of Example 5;

FIG. 10 is a graph showing the increase of micro/macro nutrients in parsley of Example 5;

FIG. 11 is a graph showing the increase in tissue mass in pansy flowers of Example 6;

FIG. 12 is a graph showing the increase in tissue mass in dianthus flowers of Example 6;

FIG. 13 is a graph showing the increase in biomass and fruit yield in tomatoes for the potting mix media of Example 7;

FIG. 14 is a graph showing the increase in biomass and fruit yield in tomatoes for the field soil media of Example 7;

FIG. 15 is a graph showing the decrease in fruit rot in tomatoes for the potting mix media of Example 7; and

FIG. 16 is a graph showing the decrease in fruit rot in tomatoes for the field soil media of Example 7.

### DETAILED DESCRIPTION

This disclosure provides compositions and methods that treat plants to accelerate vegetation and reproductive growth. The compositions can be applied by any suitable method, such as injection, drip, broadcast, banding, soil drench, foliar, fertigation, aerially, or other conventional methods, or any combination thereof. As further discussed below, the compositions increase nutrient assimilation, water uptake, health, yield, shelf life and overall plant growth and vigor. As used herein, “vigor” of a plant means plant weight (including tissue mass or root mass, or a combination thereof), plant height, plant canopy, visual appearance, or any combination of these factors. Thus, increased vigor refers to an increase in any of these factors by a measurable or visible amount when compared to the same plant that has not been treated with the compositions disclosed herein.

The compositions include (1) a biological compound, (2) a surfactant, (3) a supramolecular host or guest chemical configured to engage in host-guest chemistry with the biological compound or the surfactant, or both, and (4) a solvent. When components (1)-(4) are mixed together, supramolecular structures are formed that have an enhanced synergy that allow increased nutrition assimilation, water uptake, yield, shelf life, overall plant growth, plant vigor, or a combination thereof, in a plant to which such compositions is applied. Such supramolecular structures or assemblies may take the form of, e.g., micelles, liposomes, nanostructures, or nanobubbles. Advantageously, the compositions increase plant biomass, total nutrient uptake, yield, total micronutrient uptake, total macronutrient uptake, uptake of one or more of the following elements: nickel, copper, zinc, manganese, iron, molybdenum, boron, calcium, sulfur, phosphorus, magnesium, calcium, potassium, nitrogen, carbon; or a combination of the foregoing.

In various embodiments, the biological compound includes one or more protein extracts. In certain embodiments, the biological compound (1) is grown in an aerobic fermentation process, (2) contains proteins or protein fragments having a molecular weight of less than 1000 kilodaltons (kDa), and (3) contains no living microbes. The biological compounds can be extracted by various methods, and in exemplary embodiments, include one or more: carbohydrates, lipids, proteins, peptides, nucleic acids, or a combination thereof. For example, the biological compounds may include one or more of each of a: protein extract (e.g., yeast extract, or any other plant-derived protein hydrolysate), amino acid (e.g., glutamine, histidine, cysteine, and tryptophan), or sugar (e.g., beet or cane sugar, brown sugar, high fructose corn syrup, any other plant-based sugar, and various types of molasses); and combinations of any of the foregoing. In some embodiments, the protein extract includes a yeast extract from the genus Saccharomyces. Any suitable Saccharomyces species may be used, including Saccharomyces cerevisiae, Saccharomyces paradoxus, Saccharomyces bayanus, or Saccharomyces cerevisiae var boulardii, or any combination thereof. Advantageously, the compositions including the protein extracts are stable (i.e., the protein in the protein extracts do not significantly denature) for at least 6 weeks when subjected to temperatures of 40° F. to 140° F. By “not significant” is meant less than 5% change in protein, for example less than about 4% change in protein.

The biological compound is present in any suitable amount, but is generally present in the composition in an amount of about 0.1 percent to about 90 percent by weight of the composition. In some embodiments, the biological compound is present in an amount of about 10 percent to about 50 percent, for example 20 percent to about 30 percent, by weight of the composition. In certain embodiments, the biological compound is present an amount of about 5 percent to about 50 percent by weight of the composition, for example, about 10 percent to about 45 percent by weight of the composition, about 15 percent to about 40 percent by weight of the composition, or about 20 percent to about 35 percent by weight of the composition.

In several embodiments, the surfactant includes a non-ionic, anionic, cationic, or zwitterionic surfactant. Suitable non-ionic surfactants include, but are not limited to, fatty alcohol ethoxylate, alkyl phenol ethoxylate, alkyl polyglycoside, cocamide diethanolamine (DEA)/monoethanolamine (MEA), decyl polyglucose, octaethylene glycol monododecyl ether, oleyl alcohol, polysorbate, sorbitan, Tween® 80, fatty acid alkoxylate, or any combination thereof. Suitable anionic surfactants include, but are not limited to, 2-acrylamido-2-methylpropane sulfonic acid, alkylbenzene sulfonates, chlorosulfolipid, magnesium laureth sulfate, perfluorobutanesulfonic acid, sodium laureth sulfate, sodium sulfosuccinate esters, sodium lauroyl sarcosinate, or any combination thereof. Suitable cationic surfactants include, but are not limited to, benzalkonium chloride, carbethopendecinium chloride, didecyldimethylammonium chloride, lauryl methyl gluceth-10 hydroxypropyl dimonium chloride, octenidine dihydrochloride, stearalkonium chloride, tetramethylammonium hydroxide, siloxanes (e.g., siloxane copolymers), or any combination thereof. Suitable zwitterionic surfactants include, but are not limited to, cocamidopropyl betaine, dipalmitoyl phosphatidylcholine, sodium lauroamphoacetate, lecithin, or miltefosine, or any combination thereof. In one embodiment, the surfactant includes one or more polyether polydimethyl siloxane copolymers

The surfactant is present in any suitable amount, but is generally present in the composition in an amount of about 0.1 percent to about 50 percent by weight of the composition. In certain embodiments, the surfactant is present in an amount of about 1 percent to about 30 percent by weight of the composition, for example, 5 percent to about 20 percent by weight of the composition. In some embodiment, the surfactant is present in an amount of about 0.5 percent to about 50 percent by weight of the composition, for example, about 3 percent to about 45 percent by weight of the composition, about 10 percent to about 40 percent by weight of the composition, or about 15 percent to about 30 percent by weight of the composition.

In selecting suitable supramolecular host or guest chemical(s), (1) the host chemical generally has more than one binding site, (2) the geometric structure and electronic properties of the host chemical and the guest chemical typically complement each other when at least one host chemical and at least one guest chemical is present, and (3) the host chemical and the guest chemical generally have a high structural organization, i.e., a repeatable pattern often caused by host and guest compounds aligning and having repeating units or structures. In some embodiments, the supramolecular host chemical or supramolecular guest chemical is provided in a mixture with water. Host chemicals may include nanostructures of various elements and compounds, which may have a charge, may have magnetic properties, or both. Suitable supramolecular host chemicals include cavitands, cryptands, rotaxanes, catenanes, or any combination thereof.

Cavitands are container-shaped molecules that can engage in host-guest chemistry with guest molecules of a complementary shape and size. Examples of cavitands include cyclodextrins, calixarenes, pillarrenes, and cucurbiturils. Calixarenes are cyclic oligomers obtained by condensation reactions between para-t-butyl phenol and formaldehyde.

Cryptands are molecular entities including a cyclic or polycyclic assembly of binding sites that contain three or more binding sites held together by covalent bonds, and that define a molecular cavity in such a way as to bind guest ions. An example of a cryptand is N[CH₂CH₂OCH₂CH₂OCH₂CH2 ]₃N or 1,10-diaza-4,7,13,16,21,24-hexaoxabicyclo[8.8.8]hexacosane. Cryptands form complexes with many cations, including NH₄⁺, lanthanoids, alkali metals, and alkaline earth metals.

Rotaxanes are supramolecular structures in which a cyclic molecule is threaded onto an “axle” molecule and end-capped by bulky groups at the terminal of the “axle” molecule. Another way to describe rotaxanes are molecules in which a ring encloses another rod-like molecule having end-groups too large to pass through the ring opening. The rod-like molecule is held in position without covalent bonding.

Catenanes are species in which two ring molecules are interlocked with each other, i.e., each ring passes through the center of the other ring. The two cyclic compounds are not covalently linked to one another, but cannot be separated unless covalent bond breakage occurs.

Suitable supramolecular guest chemicals include cyanuric acid, water, and melamine, and are preferably selected from cyanuric acid or melamine, or a combination thereof. Another category of guest chemicals includes nanostructures of various elements and compounds, which may have a charge, may have magnetic properties, or both.

The supramolecular host chemical or the supramolecular guest chemical is present in the composition in any suitable amount, but is generally present in the composition in an amount of about 1 percent to about 90 percent by weight of the composition. In certain embodiments, the supramolecular host chemical or supramolecular guest chemical, or host and guest chemical combination, is present in an amount of about 50 percent to about 85 percent by weight of the composition, for example, 60 percent to about 80 percent by weight of the composition. In other embodiments, the supramolecular host chemical or supramolecular guest chemical, or host and guest chemical combination, is present in an amount of about 25 percent to about 90 percent by weight of the composition, for example, about 30 percent to about 85 percent by weight of the composition, about 40 percent to about 80 percent by weight of the composition, about 45 percent to about 75 percent by weight of the composition, or about 50 percent to about 70 percent by weight of the composition.

The solvent may include any polar solvent, including for example water or any alcohol. Water is used as a preferred solvent for the different components of the composition. Water (or other polar solvent) is present in any suitable amount, but is generally present in the composition in an amount of about 0.1 percent to about 50 percent by weight of the composition. In certain embodiments, the polar solvent, such as water, is present in an amount of about 1 percent to about 45 percent by weight of the composition, for example, 20 percent to about 40 percent by weight of the composition. In other embodiments, the polar solvent is present in an amount of about 5 percent to about 50 percent by weight of the composition, for example about 10 percent to about 45 percent by weight of the composition, 15 percent to about 40 percent by weight of the composition, or about 20 percent to about 35 percent by weight of the composition.

The order of addition of the components of the composition can be important to obtain stable supramolecular structures or assemblies in the final mixture. The order of addition is typically: (1) solvent, (2) biological product, and (3) surfactant. Once these three components are fully mixed, the supramolecular host or guest chemical is added to the mixture and allowed to mix thoroughly with the other initial components.

The compositions described above are typically applied in an agriculturally effective amount to each plant. These compositions are preferably formed as a concentrate, which is “reconstituted” or otherwise diluted before application to the relevant vegetation (e.g., crops, plants, trees, etc.). The dilution typically occurs on or adjacent the site of application to minimize the need to transport large volumes of the product. The amount or concentration of the present compositions can vary depending on conditions (e.g., soil, humidity, pH, temperature, growing season, amount of daily light, etc.), the concentration and type of components as described herein, as well as the type of plant to which each composition is applied. In some embodiments, an “agriculturally effective amount” means from about 0.1 mL to 150 mL of the composition per gallon can be applied to saturate per pot of plant (e.g., 0.1 mL to 2 mL per gallon, 3 mL to 90 mL per gallon, or 90 mL to 150 mL per gallon), or from about 20 mL to 100 mL of the solution made, and if the product is to be applied over a field then from about 0.1 qt to 1 qt concentrate of the product with about 5 to 100 gallons of water per acre. In several embodiments, application of an agriculturally effective amount of the composition increases one or more of nutrition assimilation, water uptake, yield, shelf life, overall plant growth, or plant vigor.

The compositions described above are typically applied in an agriculturally effective amount to each plant. In some situations, the compositions may be applied in combination with various additives such as macronutrients or micronutrients, a plant growth regulator, a crop protectant, a pH buffer, a defoamer, a drift control agent, a sticker, a spreader, a tank cleaner, or a biostimulant. When an additive is mixed with the composition, each additive (or a combination of additives) may be present at an amount of less than 50 percent (e.g., about 10 percent to about 30 percent) by weight of the composition and additives. When the additive is applied separately from the composition, the amount of additive will vary, and often depends in part on the crop the additive is being applied to and the relevant environmental conditions. In various embodiments, a fertilizer or nutrient composition is applied in combination with the composition, for example the fertilizer may be mixed together with the composition or may be applied separately from the composition, either at the same time or sequentially at about the same time, e.g., within a day, or even within 8 hours. As used herein, a “fertilizer” is any natural or synthetic substance that is applied to soil or plants to improve growth and productivity. Fertilizers provide nutrients to plants. The fertilizer that can be utilized can be any chemical moiety, natural or synthetic, that serves as a source of macronutrients and/or micronutrients for the plant under consideration.

The following examples are illustrative of the compositions and methods discussed above and are not intended to be limiting.

### EXAMPLES

### Example 1: Preparation of Composition

A composition was prepared using the ingredients and quantities shown in Table 1 below. The composition used throughout the examples was made by using SWIFT WET® 200 yeast extract-surfactant combination from Advanced BioCatalytics Corporation and SymMAX™ supramolecular host (or supramolecular guest) chemistry product, which is commercially available from Shotwell Hydrogenics. As a composition control, the same composition was made with distilled water and without the SymMAX™ supramolecular host product to understand the effects of the supramolecular host.

TABLE 1
COMPOSITION COMPONENTS AND AMOUNTS

| | Example | Low | High |
|---|---|---|---|
| | Blend | Limits | Limits |
| Raw Material | (w/w %) | (w/w %) | (w/w %) |
| SWIFT WET ® 200 yeast | 30 | 0.1 | 90 |
| extract-surfactant | | | |
| combination | | | |
| SymMAX ™ supramolecular | 70 | 1 | 90 |
| host product | | | |

The biological component will either be extracted with water or dissolved with water. The surfactant will then be mixed into the extraction or solutions. The SymMax™ product is commercially available with the supramolecular host already in an aqueous solution, and this component is added to an existing mix of surfactant and biological component.

### Example 2: Effect of Composition on Viola tricolor (Garden Pansy) Growth and Nutrient Uptake

Viola tricolor (Garden Pansy) at a size of BVBB 30 (stem/rosette elongation) were transplanted at a uniform depth of 3″ into 6″ round poly nursery pots filled with a custom research soil blend (88% sand, 10% silt, and 2% clay). The pots were placed on benches in a greenhouse under natural light at 77° F. /56° F. day/night temperature as a means of providing a controlled environment. Transplants were selected from an initial group of 96 plants purchased from a local nursery based on homogeneity of plant size and physiological maturity between replicates within the trial. Selected plants had all flower buds removed to insure homogeneity of physiological maturity. Applications began one day after transplant and continued for 2 weeks. The trial consisted of 6 replicates in a Randomized Complete Block Design (RCBD) to account for variations within the microenvironment of the greenhouse. A single negative control (a 200 ppm nitrogen solution of Peters Professional 20-20-20 General Purpose fertilizer), the composition of Example 1, and the composition control of Example 1 using distilled water without any SymMax™ material, were used as the treatment. Treatment compositions were prepared having a concentration of 4 mL of the composition or the composition control per gallon.

Two applications of each treatment were applied as a drench of 120 mL/application made one week apart. An initial nutritional application of Peters Professional 20-20-20 General Purpose fertilizer was made at transplant at the rate of 200 ppm of nitrogen. At the second week after application, the whole plant was removed from each pot and the potting mix rinsed off the root system. Subsequently, the roots were separated from the leaves, and each weighed to determine total plant mass, total shoot/leaf mass, and total root mass. Shoot length and root length were also determined. Table 2 below provides the average data set from the 6 replicates.

TABLE 2
AVERAGE OF THE RESULTS

| | Shoot | Root | Total Plant | Total Nutrient |
|---|---|---|---|---|
| Treatment | Mass (g) | Mass (g) | Mass (g) | Assimilation (mg) |
| Control | 6.2 | 4.4 | 10.6 | 731.6 |
| Composition | 8.3 | 5.6 | 14 | 989.6 |
| Composition | 6.9 | 6.0 | 12.9 | 959.2 |
| Control | | | | |

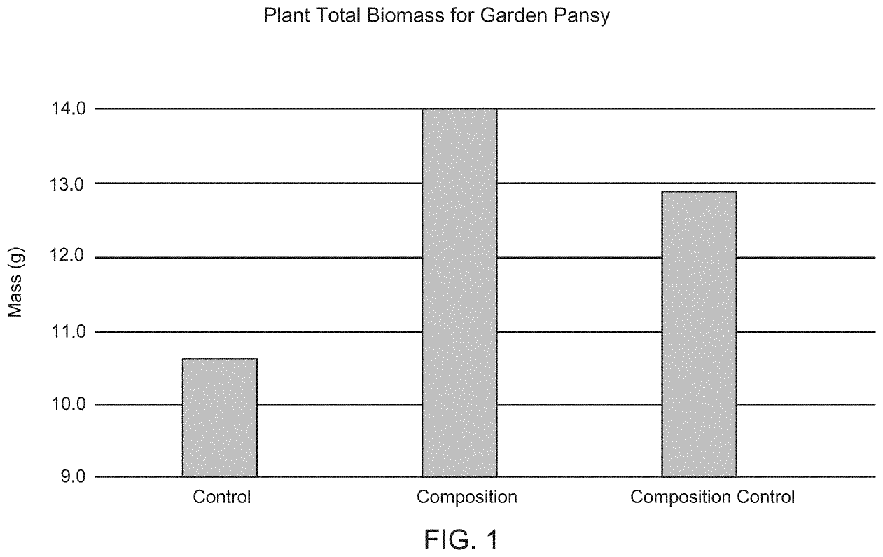

As can be seen in in FIG. 1, the total biomass of the pansies was significantly greater when treated with the composition. The total mass of the plant treated with the composition was greater by 32% compared to the mass of the control, and was 9% greater in biomass than the composition control.

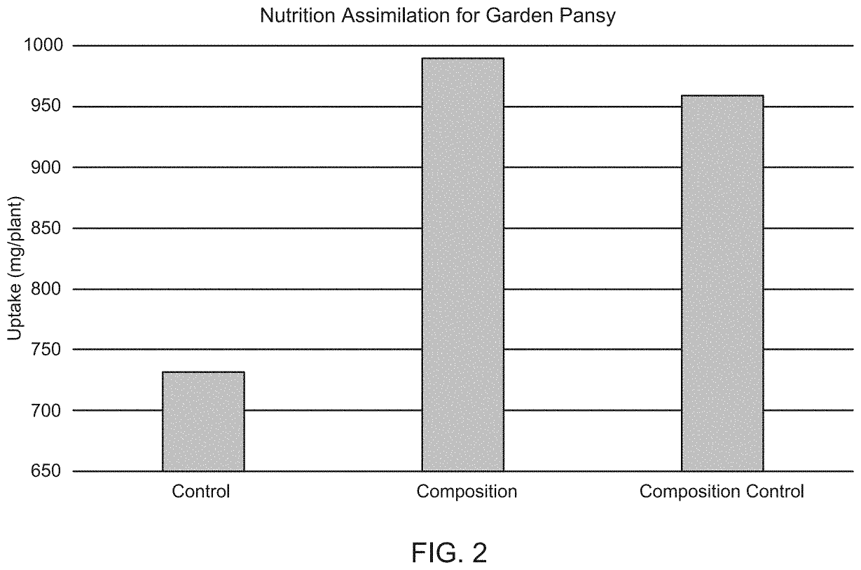

In FIG. 2, the nutrition assimilation was determined and when the composition was used, nutrient uptake was greater than the control by 35% and greater than 3% compared to the composition control. Table 3 provides the data.

TABLE 3
NUTRIENT UPTAKE MEASUREMENTS (mg/plant)

| Element | Control | Composition | Composition Control |
|---|---|---|---|
| N (%) | 292.11 | 364.13 | 332.82 |
| S (%) | 17.95 | 20.17 | 21.80 |
| P (%) | 29.32 | 28.57 | 26.57 |
| K (%) | 248.77 | 400.4 | 376.55 |
| Mg (%) | 52.26 | 63.58 | 72.11 |
| Ca (%) | 84.02 | 106.72 | 120.62 |
| B (ppm) | 0.16 | 0.15 | 0.20 |
| Zn (ppm) | 1.65 | 1.96 | 2.03 |
| Mn (ppm) | 1.81 | 1.88 | 2.58 |
| Fe (ppm) | 3.48 | 2.04 | 3.82 |
| Cu (ppm) | 0.06 | 0.06 | 0.07 |
| Total | 731.57 | 989.65 | 959.18 |

### Example 3: Effect of Composition on Protein Stability

To understand the protein stability of the composition with and without supramolecular structure formation, both the composition and composition control of Example 1 were placed at 40, 75, and 140° F. Samples were taken at weeks 0, 2, 4, and 6 and evaluated using Fourier transform infrared (FTIR) spectroscopy. The FTIR spectrum was obtained on a Thermo Scientific™ Nicolet™ iS5™ FTIR spectrometer with the iD7 ATR attachment. A total of 32 scans was collected from 850 to 1750 wavenumbers. All spectrum data was compared to the week 0 data by determining the percent change over time for all three different temperatures.

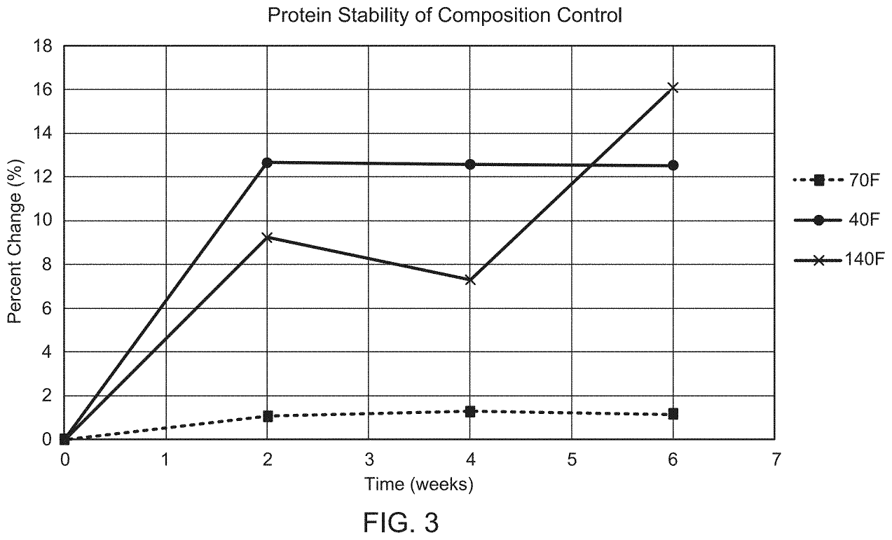

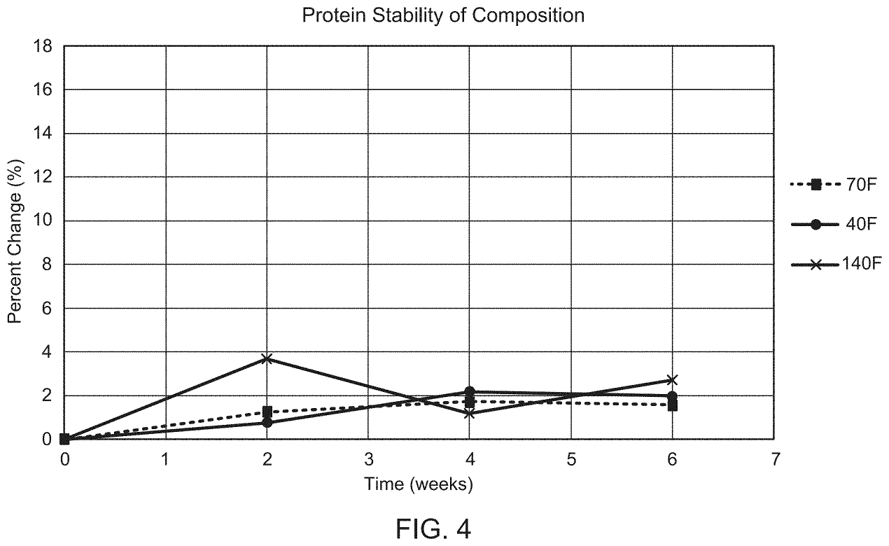

As seen in FIG. 3, the protein in the composition control denatured at cold and hot temperature quickly giving a limited shelf life. In FIG. 4, the composition showed virtually no protein denaturation, giving an indefinite shelf life. Protein denaturation is a common issue with products that have proteins, protein extracts, or biological components, normally giving either a non-useable product or finite shelf life. Without being bound by theory, it is believed that when the protein forms a supramolecular structure, it “locks” the protein in place granting an indefinite shelf life and allowing the use of proteins or extracts that would normally denature under standard conditions. Table 4 provides the data for the composition control, and Table 5 provides the data for the composition.

TABLE 4
PERCENT PROTEIN CHANGE
IN COMPOSITION CONTROL

| Week | 40° F. | 70° F. | 140° F. |
|---|---|---|---|
| 0 | 0 | 0 | 0 |
| 2 | 12.64 | 1.05 | 9.24 |
| 4 | 12.56 | 1.29 | 7.27 |
| 6 | 12.51 | 1.16 | 16.09 |

TABLE 5
PERCENT PROTEIN CHANGE IN COMPOSITION

| Week | 40° F. | 70° F. | 140° F. |
|---|---|---|---|
| 0 | 0 | 0 | 0 |
| 2 | 0.76 | 1.26 | 3.69 |
| 4 | 2.18 | 1.74 | 1.18 |
| 6 | 1.97 | 1.58 | 2.71 |

### Example 4: Effect of Composition on Lactuca sativa (leaf lettuce) Growth and Yield

Lactuca sativa (leaf lettuce) seeds, variety Paris Island, were planted at ¼″ depth in 10.63″ poly pots in commercial potting mix and placed on benches in a greenhouse under natural light at 90/77° F. day/night temperature as a means of providing a controlled environment. Lettuce seeds were allowed to germinate and reach a uniform size of BVNH 13 (3rd true leaf unfolded) and then thinned to a single plant/pot to obtain homogeneity of plant size and physiological maturity between replicates within the trial. The trial consisted of 5 replicates in a Randomized Complete Block Design (RCBD) to account for variations within the microenvironment of the greenhouse. A single control was used, and the present compositions were used in a blend at 3 different rates.

Trial treatments included a control treatment (a 200 ppm nitrogen solution of fertilizer) and treatment with the composition of Example 1 at 3 different rates/amounts. All treatments received a weekly application of a nutrient solution of 200 ppm of a 20-20-20 water soluble fertilizer mix (pH 7.2 corrected). The composition was added as an additional product to the nutrient solution and applied once per week for 4 weeks. Amounts of the composition used for this trial were 1.0 mL of the composition/gallon of the nutrient solution, 3.0 mL of the composition/gallon of the nutrient solution, and 6.0 mL of the composition/gallon of nutrient solution and were applied at a volume rate of 500 mL per pot.

At the fourth week after applications, the whole plant was removed from each pot and the potting mix rinsed off the root system. Subsequently, the roots were separated from the leaves, and each weighed to determine total plant mass, total shoot/leaf mass, and total root mass. Shoot length and root length were also determined. Table 6 below provides the average data set from the 5 replicates.

TABLE 6
AVERAGE OF THE RESULTS

| | | | Total | | |
|---|---|---|---|---|---|
| | Shoot | Root | Plant | Leaf | Root |
| | Length | Length | Mass | Mass | Mass |
| Treatment | (in) | (in) | (g) | (g) | (g) |
| Control | 10.8 | 6.6 | 111.8 | 99.4 | 12.4 |
| 1.0 mL/gal | 10.9 | 8.7 | 168.8 | 148.0 | 20.8 |
| 3.0 mL/gal | 12.2 | 9.4 | 204.0 | 180.2 | 23.8 |
| 6.0 mL/gal | 11.2 | 7.7 | 158.0 | 135.2 | 22.8 |

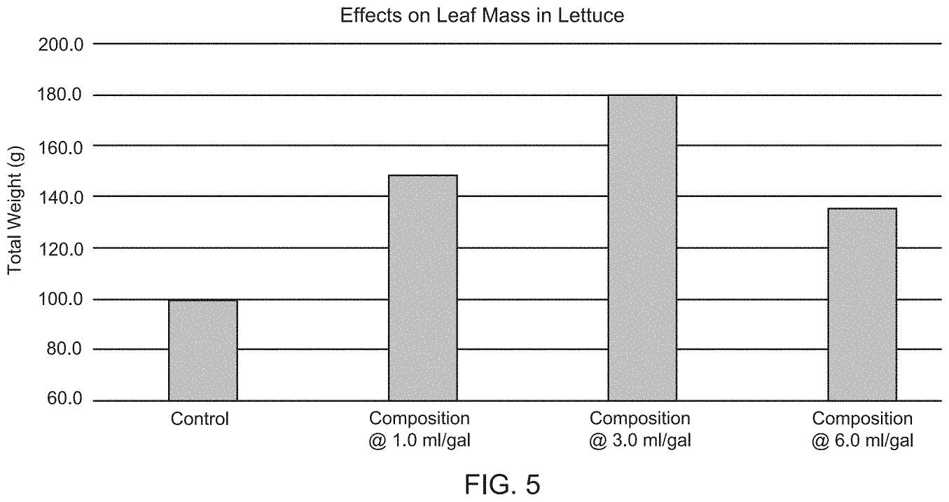

As can be seen in in FIG. 5, the leaf mass of the lettuce was significantly greater in the lettuce that was treated with the composition. Indeed, the weight of the leaf mass in the treated lettuce at 3.0 mL/gal was almost twice the weight of leaf mass in the untreated lettuce. The data was averaged from 5 replicates.

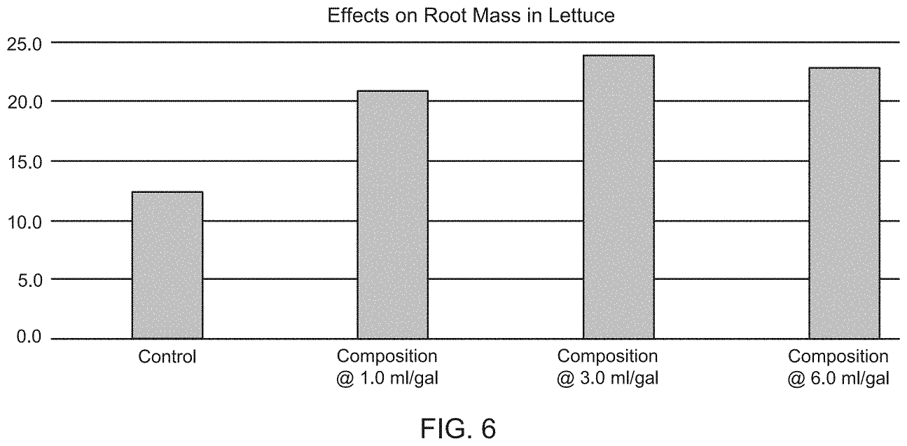

Turning now to FIG. 6, the root mass in the lettuce that was treated with the composition was greater than the root mass in the untreated lettuce. Again, the weight of the root mass in the treated lettuce for all 3 amounts was almost twice the weight of the root mass in the untreated lettuce.

The entire above-ground fresh biomass for each treatment was submitted to a plant analysis laboratory for nutrient tissue analysis. The results are provided in Tables 7-13 below.

TABLE 7
NUTRIENT UPTAKE MEASUREMENTS
FOR CONTROL

| | | Control | Control |
|---|---|---|---|
| | Control | (Total | Uptake |
| Element | (%) | Biomass) | (mg/plant) |
| N (%) | 3.800 | 111.8 | 4.25 |
| P (%) | 0.650 | 111.8 | 0.73 |
| K (%) | 5.480 | 111.8 | 6.13 |
| Na (%) | 0.150 | 111.8 | 0.17 |
| Ca (%) | 0.820 | 111.8 | 0.92 |
| Mg (%) | 0.330 | 111.8 | 0.37 |
| Fe (ppm) | 0.022 | 111.8 | 0.03 |
| Cu (ppm) | 0.001 | 111.8 | 0.00 |
| Zn (ppm) | 0.008 | 111.8 | 0.01 |
| Mn (ppm) | 0.006 | 111.8 | 0.01 |
| B (ppm) | 0.002 | 111.8 | 0.00 |

TABLE 8
NUTRIENT UPTAKE MEASUREMENTS
FOR 1.0 mL/gal

| | | | | Percentage |
|---|---|---|---|---|
| | | | | Increase |
| | Measured | Total | Uptake | Compared |
| Element | (%) | Biomass | (mg/plant) | to Control |
| N (%) | 3.60 | 168.8 | 6.08 | 43.04 |
| P (%) | 0.60 | 168.8 | 1.01 | 39.37 |
| K (%) | 4.96 | 168.8 | 8.36 | 36.52 |
| Na (%) | 0.10 | 168.8 | 0.17 | 0.66 |
| Ca (%) | 0.55 | 168.8 | 0.92 | 0.35 |
| Mg (%) | 0.26 | 168.8 | 0.44 | 18.96 |
| Fe (ppm) | 0.02 | 168.8 | 0.03 | 7.51 |
| Cu (ppm) | 0.00 | 168.8 | 0.00 | 27.14 |
| Zn (ppm) | 0.01 | 168.8 | 0.01 | 22.13 |
| Mn (ppm) | 0.00 | 168.8 | 0.01 | -8.62 |
| B (ppm) | 0.00 | 168.8 | 0.00 | 28.01 |

TABLE 9
NUTRIENT UPTAKE MEASUREMENTS
FOR 3.0 mL/gal

| | | | | Percentage |
|---|---|---|---|---|
| | | | | Increase |
| | Measured | Total | Uptake | Compared |
| Element | (%) | Biomass | (mg/plant) | to Control |
| N (%) | 4.0500 | 204.00 | 8.26 | 94.5 |
| P (%) | 0.7000 | 204.00 | 1.43 | 96.5 |
| K (%) | 5.2200 | 204.00 | 10.65 | 73.8 |
| Na (%) | 0.1200 | 204.00 | 0.24 | 46.0 |
| Ca (%) | 0.6000 | 204.00 | 1.22 | 33.5 |
| Mg (%) | 0.2950 | 204.00 | 0.60 | 63.1 |
| Fe (ppm) | 0.0187 | 204.00 | 0.04 | 52.3 |
| Cu (ppm) | 0.0009 | 204.00 | 0.00 | 63.3 |
| Zn (ppm) | 0.0072 | 204.00 | 0.01 | 66.2 |
| Mn (ppm) | 0.0044 | 204.00 | 0.01 | 40.9 |
| B (ppm) | 0.0021 | 204.00 | 0.00 | 66.6 |

TABLE 10
NUTRIENT UPTAKE MEASUREMENTS
FOR 6.0 mL/gal

| | | | | Percentage |
|---|---|---|---|---|
| | | | | Increase |
| | Measured | Total | Uptake | Compared |
| Element | (%) | Biomass | (mg/plant) | to Control |
| N (%) | 4.1 | 158 | 6.478 | 52.48 |
| P (%) | 0.7 | 158 | 1.106 | 52.19 |
| K (%) | 5.225 | 158 | 8.2555 | 34.75 |
| Na (%) | 0.165 | 158 | 0.2607 | 55.46 |
| Ca (%) | 0.675 | 158 | 1.0665 | 16.33 |
| Mg (%) | 0.315 | 158 | 0.4977 | 34.90 |
| Fe (ppm) | 0.02235 | 158 | 0.035313 | 41.01 |
| Cu (ppm) | 0.0008 | 158 | 0.001264 | 19.01 |
| Zn (ppm) | 0.0071 | 158 | 0.011218 | 27.82 |
| Mn (ppm) | 0.00425 | 158 | 0.006715 | 5.37 |
| B (ppm) | 0.0021 | 158 | 0.003318 | 29.03 |

TABLE 11
PERCENTAGE INCREASE COMPARED TO CONTROL

| Element | 1.0 mL/gal | 3.0 mL/gal | 6.0 mL/gal |
|---|---|---|---|
| N (%) | 43.04 | 94.47 | 52.48 |
| P (%) | 39.37 | 96.50 | 52.19 |
| K (%) | 36.52 | 73.81 | 34.75 |
| Na (%) | 0.66 | 45.97 | 55.46 |
| Ca (%) | 0.35 | 33.51 | 16.33 |
| Mg (%) | 18.96 | 63.12 | 34.90 |
| Fe (ppm) | 7.51 | 52.33 | 41.01 |
| Cu (ppm) | 27.14 | 63.26 | 19.01 |
| Zn (ppm) | 22.13 | 66.20 | 27.82 |
| Mn (ppm) | -8.62 | 40.85 | 5.37 |
| B (ppm) | 28.01 | 66.60 | 29.03 |

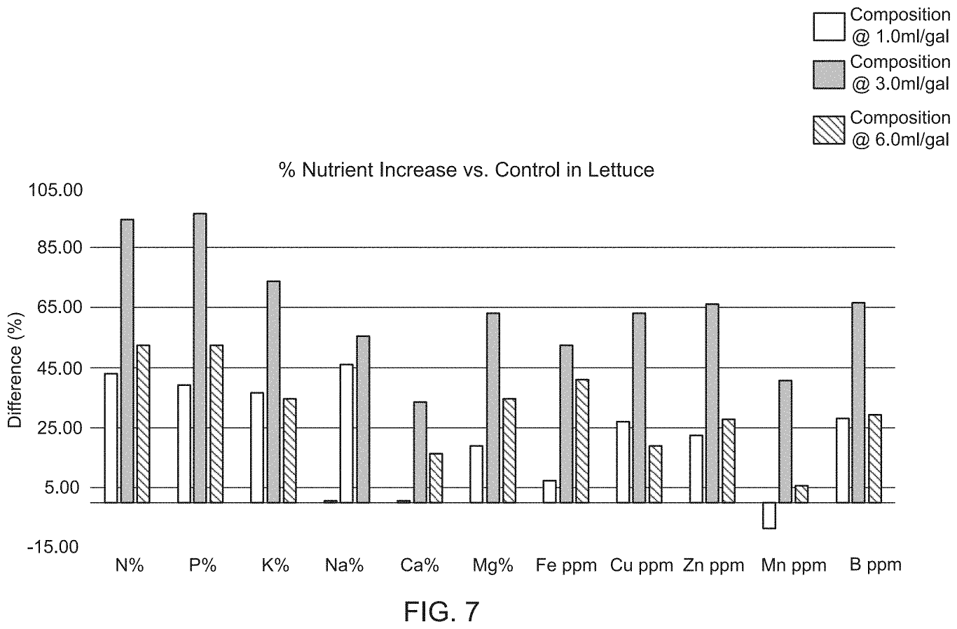

Referring now to FIG. 7, the percentage of nutrient increase in the treated lettuce was generally greater than the percentage of nutrient increase in the control lettuce. FIG. 7 shows that the 3.0 mL/gal concentration worked better at increasing the uptake of nutrients than the other 2 concentrations tested.

### Example 5: Effect of Composition on Petroselinum crispum (parsley) Growth and Yield

Petroselinum crispum (parsley) seeds, variety Peione, were planted at ¼″ depth in 10.63″ poly pots in commercial potting mix and placed on benches in a greenhouse under natural light at 90/77° F. day/night temperature as a means of providing a controlled environment. Parsley seeds were allowed to germinate and reach a uniform size of BDIC 13 (3rd true leave, leaf pairs or whorls unfolded) and then thinned to a single plant/pot to obtain homogeneity of plant size and physiological maturity between replicates within the trial. The trial consisted of 5 replicates in a Randomized Complete Block Design (RCBD) to account for variations within the microenvironment of the greenhouse.

Trial treatments included a control treatment (a 200 ppm nitrogen solution of fertilizer) and treatment with the composition of Example 1 at 3 different amounts. All treatments received a weekly application of a nutrient solution of a 20-20-20 (lb/acre) N-P-K water soluble fertilizer mix (pH 7.2 corrected), which imparts a concentration of 200 ppm to the soil. The composition was added as an additional product to the nutrient solution and applied once per week for 4 weeks. Amounts of the composition used for this trial were 0.5 mL of the composition/gallon of the nutrient solution, 1.0 mL of the composition/gallon of the nutrient solution, and 3.0 mL of the composition/gallon of nutrient solution and were applied at a volume rate of 500 mL per pot.

At the fourth week after applications, the whole plant was removed from each pot and potting mix rinsed off the root system. Subsequently, the roots were separated from leaves and each weighed to determine total plant mass, total shoot/leaf mass, and total root mass. Shoot length and root length were also determined. Table 12 below provides the average data set from the 5 replicates.

TABLE 12
AVERAGE OF THE RESULTS

| | | | Total | | |
|---|---|---|---|---|---|
| | Shoot | Root | Plant | Leaf | Root |
| | Length | Length | Mass | Mass | Mass |
| Treatment | (in) | (in) | (g) | (g) | (g) |
| Control | 9.3 | 5.8 | 80.4 | 60.2 | 19.4 |
| 0.5 mL/gal | 12.3 | 6.8 | 141.0 | 106.2 | 32.1 |
| 2.0 mL/gal | 11.6 | 6.6 | 130.8 | 98.4 | 30.8 |
| 3.0 mL/gal | 12.1 | 7.4 | 143.4 | 107.2 | 34.2 |

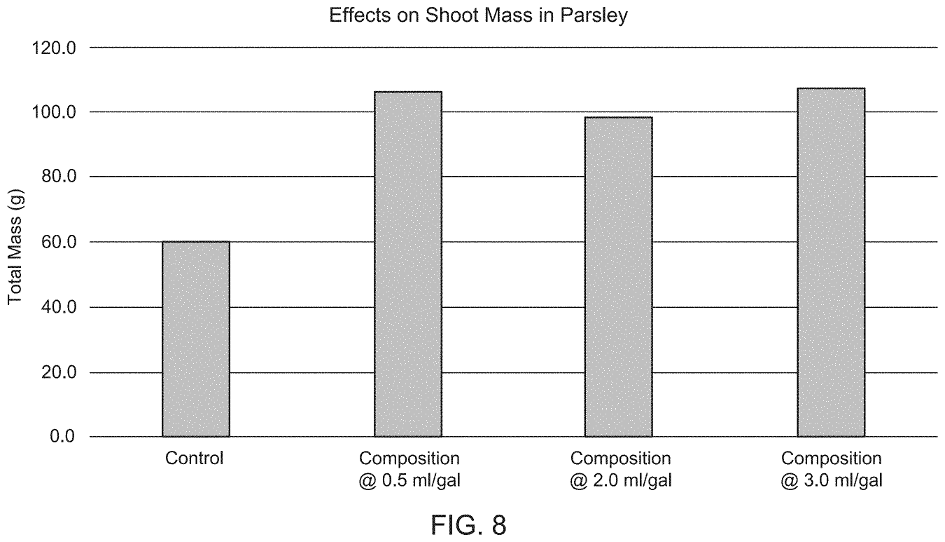

As can be seen in in FIG. 8, the shoot mass in the parsley was significantly greater in the parsley that was treated with the composition. Indeed, the weight of the shoot mass in the treated parsley was almost twice the weight of the shoot mass in the untreated parsley.

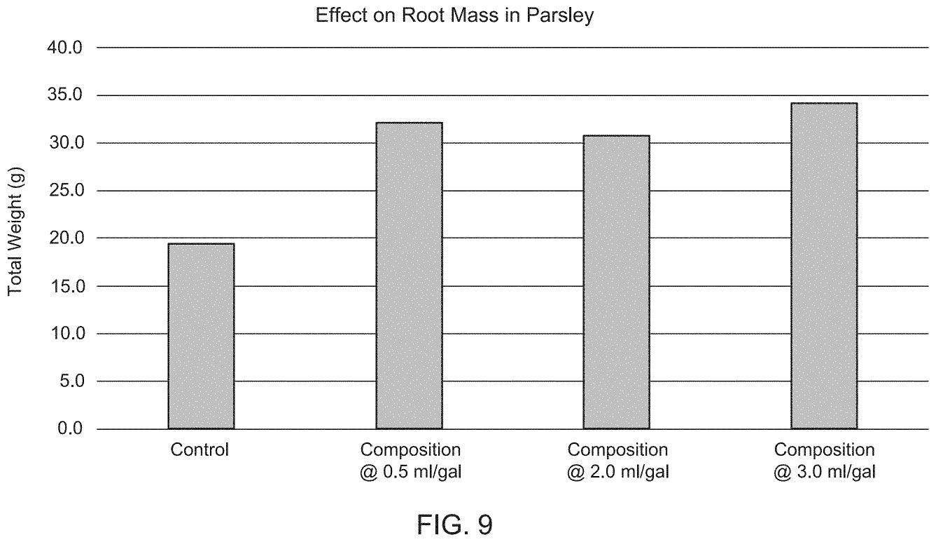

Referring now to FIG. 9, the root mass in the parsley that was treated with the composition was greater than the root mass in the untreated parsley. Again, the weight of the root mass in the treated parsley was almost twice the weight of the root mass in the untreated parsley.

The entire above-ground fresh biomass for each treatment was submitted to a plant analysis laboratory for nutrient tissue analysis. The results are provided in Tables 13-17 below.

TABLE 13
NUTRIENT UPTAKE MEASUREMENTS
FOR CONTROL

| | | Control | Control |
|---|---|---|---|
| | Control | (Total | Uptake |
| Element | (%) | Biomass) | (mg/plant) |
| N (%) | 3.90 | 80.4 | 3.14 |
| P (%) | 0.37 | 80.4 | 0.30 |
| K (%) | 4.47 | 80.4 | 3.59 |
| Na (%) | 0.23 | 80.4 | 0.18 |
| Ca (%) | 1.03 | 80.4 | 0.82 |
| Mg (%) | 0.46 | 80.4 | 0.37 |
| Fe (ppm) | 0.0175 | 80.4 | 0.014 |
| Cu (ppm) | 0.0009 | 80.4 | 0.00068 |
| Zn (ppm) | 0.009 | 80.4 | 0.0072 |
| Mn (ppm) | 0.0052 | 80.4 | 0.0042 |
| B (ppm) | 0.0034 | 80.4 | 0.0027 |

TABLE 14
NUTRIENT UPTAKE MEASUREMENTS
FOR 0.5 mL/gal

| | | | | Percentage |
|---|---|---|---|---|
| | | | | Increase |
| | Measured | Total | Uptake | Compared |
| Element | (%) | Biomass | (mg/plant) | to Control |
| N (%) | 3.90 | 141 | 5.50 | 75.4 |
| P (%) | 0.41 | 141 | 0.57 | 92.0 |
| K (%) | 4.78 | 141 | 6.74 | 87.5 |
| Na (%) | 0.21 | 141 | 0.30 | 63.7 |
| Ca (%) | 1.03 | 141 | 1.45 | 76.2 |
| Mg (%) | 0.45 | 141 | 0.63 | 67.82 |
| Fe (ppm) | 0.035 | 141 | 0.050 | 253.3 |
| Cu (ppm) | 0.0012 | 141 | 0.0017 | 147.6 |
| Zn (ppm) | 0.0064 | 141 | 0.0090 | 24.7 |
| Mn (ppm) | 0.0058 | 141 | 0.0081 | 93.9 |
| B (ppm) | 0.0034 | 141 | 0.0050 | 78.0 |

TABLE 15
NUTRIENT UPTAKE MEASUREMENTS
FOR 2.0 mL/gal

| | | | | Percentage |
|---|---|---|---|---|
| | | | | Increase |
| | Measured | Total | Uptake | Compared |
| Element | (%) | Biomass | (mg/plant) | to Control |
| N (%) | 3.75 | 130.8 | 4.91 | 25.8 |
| P (%) | 0.38 | 130.8 | 0.50 | 22.7 |
| K (%) | 4.75 | 130.8 | 6.2 | 30.0 |
| Na (%) | 0.28 | 130.8 | 0.37 | 74.4 |
| Ca (%) | 1.00 | 130.8 | 1.30 | 26.4 |
| Mg (%) | 0.44 | 130.8 | 0.57 | 27.9 |
| Fe (ppm) | 0.037 | 130.8 | 0.048 | 36.9 |
| Cu (ppm) | 0.0012 | 130.8 | 0.0016 | 30.8 |
| Zn (ppm) | 0.0066 | 130.8 | 0.0089 | 33.9 |
| Mn (ppm) | 0.0057 | 130.8 | 0.0074 | 28.5 |
| B (ppm) | 0.0033 | 130.8 | 0.0043 | 27.0 |

TABLE 16
NUTRIENT UPTAKE MEASUREMENTS
FOR 3.0 mL/gal

| | | | | Percentage |
|---|---|---|---|---|
| | | | | Increase |
| | Measured | Total | Uptake | Compared |
| Element | (%) | Biomass | (mg/plant) | to Control |
| N (%) | 3.75 | 143.4 | 5.38 | 71.5 |
| P (%) | 0.40 | 143.4 | 0.57 | 90.4 |
| K (%) | 4.30 | 143.4 | 6.2 | 71.8 |
| Na (%) | 0.27 | 143.4 | 0.39 | 114.0 |
| Ca (%) | 0.99 | 143.4 | 1.41 | 71.4 |
| Mg (%) | 0.45 | 143.4 | 0.65 | 72.6 |
| Fe (ppm) | 0.026 | 143.4 | 0.037 | 166.3 |
| Cu (ppm) | 0.0011 | 143.4 | 0.0016 | 130.8 |
| Zn (ppm) | 0.0062 | 143.4 | 0.0089 | 22.7 |
| Mn (ppm) | 0.0053 | 143.4 | 0.0076 | 81.8 |
| B (ppm) | 0.0034 | 143.4 | 0.0048 | 78.4 |

TABLE 17
PERCENTAGE INCREASE COMPARED TO CONTROL

| Element | 0.5 mL/gal | 2.0 mL/gal | 3.0 mL/gal |
|---|---|---|---|
| N (%) | 75.37 | 25.77 | 71.50 |
| P (%) | 91.96 | 22.73 | 90.41 |
| K (%) | 87.54 | 29.98 | 71.58 |
| Na (%) | 63.68 | 74.40 | 114.03 |
| Ca (%) | 76.23 | 26.36 | 71.40 |
| Mg (%) | 67.83 | 27.86 | 72.60 |
| Fe (ppm) | 253.26 | 36.94 | 166.26 |
| Cu (ppm) | 147.59 | 30.80 | 130.82 |
| Zn (ppm) | 24.71 | 33.87 | 22.87 |
| Mn (ppm) | 93.92 | 28.53 | 81.79 |
| B (ppm) | 77.99 | 26.95 | 78.36 |

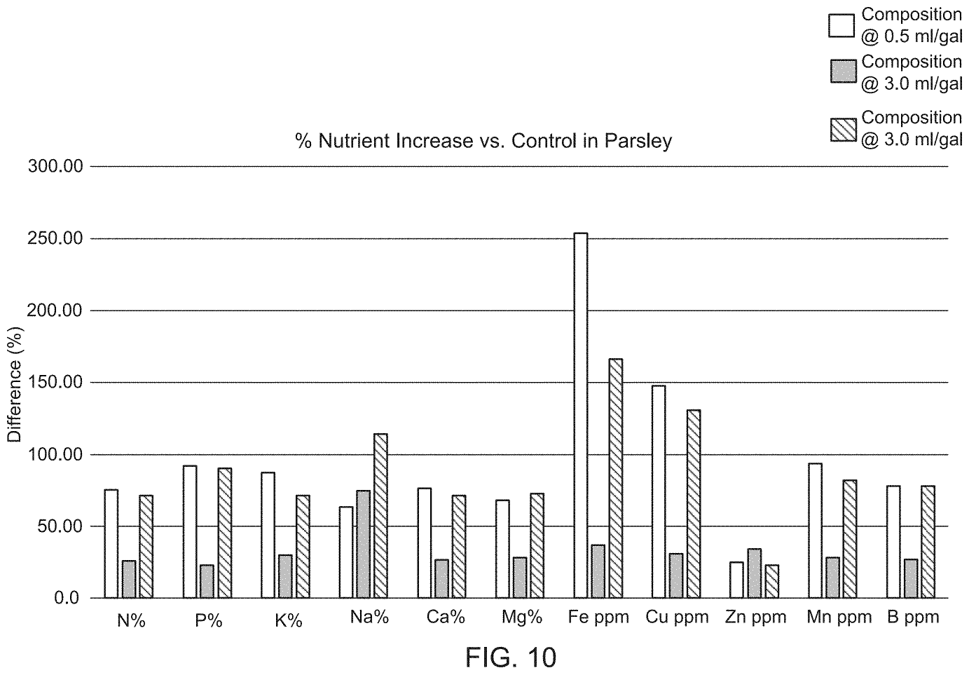

Turning now to FIG. 10, the percentage of nutrient increase in the treated parsley for the 3 concentrations was greater than the percentage of nutrient increase in the control parsley.

### Example 6: Effect of Composition on Pansy and Dianthus Flowers in Drought Conditions

Pansy and dianthus flowers were purchased from a store in a 4 pack. The flowers were placed in a growth chamber at 75° F. with controlled light-emitting diode (LED) lighting. The flowers were allowed to sit for two weeks with daily watering. After two weeks, a set of flowers (4 representatives) were treated with the composition of Example 1 by saturating the soil with a diluted solution (5 mL composition/1 gallon of water). The pots were treated twice over a two-day period. Control pots were watered the days the treated pots were treated with equivalent amounts of water.

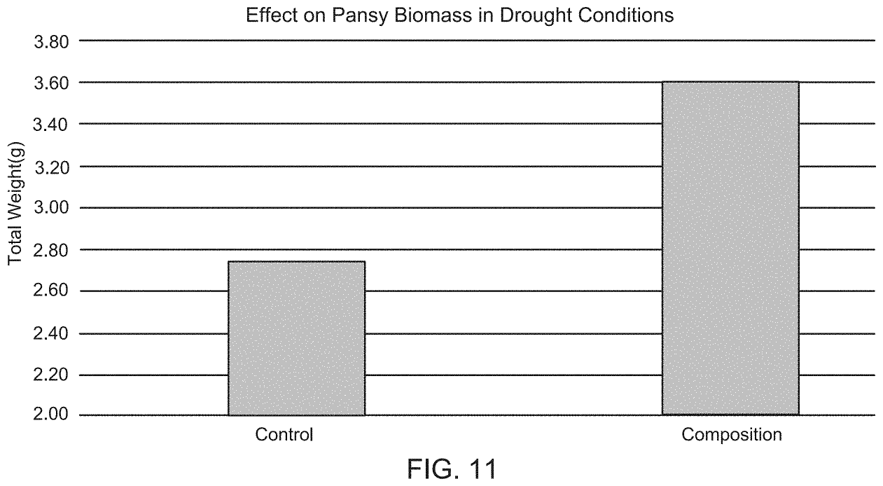

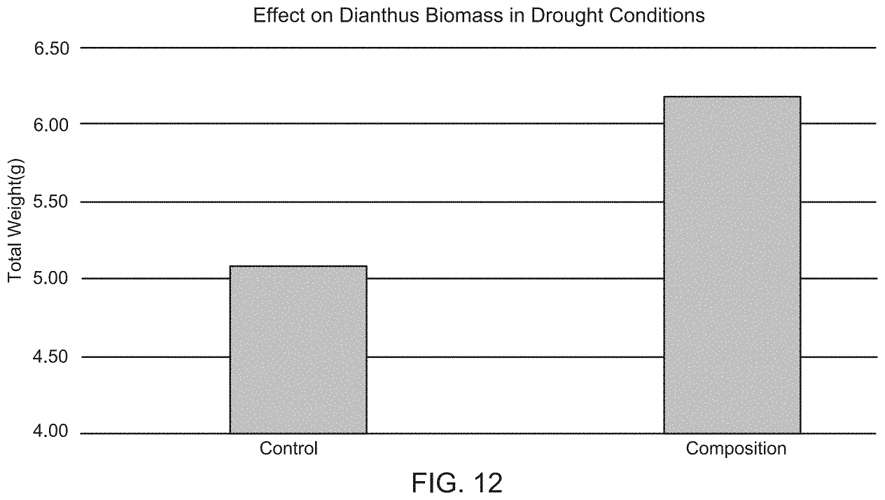

After the pots were treated all pots were allowed to go to drought conditions. Pots were watered after 1 week at drought conditions. At the 10-day mark all plant tissue was removed, weighed, and compared. Treated pansy flowers had an increase of 31.5% in biomass (see FIG. 11) and treated dianthus flowers had an increase of 21.4% in biomass (see FIG. 12). Table 18 provides the data for pansy flowers, and Table 19 provides the data for dianthus flowers.

TABLE 18
RESULTS FOR PANSY FLOWERS

| | Wet Weight | Percent |
|---|---|---|
| | (g) | Difference |
| Control | 2.74 | |
| Composition | 3.60 | 31.55 |

TABLE 19
RESULTS FOR DIANTHUS FLOWERS

| | Wet Weight | Percent |
|---|---|---|
| | (g) | Difference |
| Control | 5.09 | |
| Composition | 6.18 | 21.43 |

### Example 7: Effect of Composition on Solanum lycopersicum (tomato) Growth and Yield

Solanum lycopersicum (tomato), variety Verona Tall Vine, were planted at a uniform depth of ¼″ into 10.63″ round poly nursery pots filled with Kellogg Organics Potting Mix or field soil that was obtained from a research field in Sanger, Calif. The pots were placed on benches in a greenhouse under natural light at 86/72° F. day/night temperature as a means of providing a controlled environment. Tomato plants for the trial were selected from an initial group of 120 plants based on homogeneity of plant size and physiological maturity between replicates within the trial. Plants were allowed to grow and reach a uniform size of BVSO 21 (first side shoot visible) prior to applications beginning. The trial consisted of 5 replicates in a Strip-Block Design (STRBLO) to account for variations within the microenvironment of the greenhouse. A nutritional solution of 200 ppm nitrogen of Peter's Professional 20-20-20 General Purpose Fertilizer was applied with each treatment application. A single control (a 200 ppm nitrogen solution of fertilizer) was used, and the present composition was used, each at a rate of 10 mL per gallon. Nine applications were made at weekly intervals at the various treatment rates until BVSO 71 (1^{st} fruit cluster). Drench rate was 500 mL/application.

At 40 days after application, the whole plant was removed from each pot and potting mix or soil was rinsed off the root system. Subsequently, the tomatoes were separated from the shoots and each weighed to determine total plant mass, total tomato count, and total yield weight. The tomatoes were left to sit for 14 days to determine how many tomatoes would rot. A tomato was considered rotten when it was not eatable. Table 20 below provides the average data set from the 5 replicates.

TABLE 20
AVERAGE OF THE RESULTS

| | Pot | Total | Fruit Yield | Fruit | Rotten | Percent |
|---|---|---|---|---|---|---|
| Treatment | Media | Biomass (g) | (g) | Count | Fruit | Rotten |
| Control | Potting | 690.2 | 332.4 | 26.2 | 5.6 | 21.4 |
| | Mix | | | | | |
| Composition | Potting | 795.6 | 626.6 | 44.6 | 5.4 | 12.1 |
| at 10 mL/gal | Mix | | | | | |
| Control | Field Soil | 593.4 | 123.6 | 12 | 5.5 | 45.8 |
| Composition | Field Soil | 612.0 | 292.8 | 26 | 5.6 | 21.6 |
| at 10 mL/gal | | | | | | |

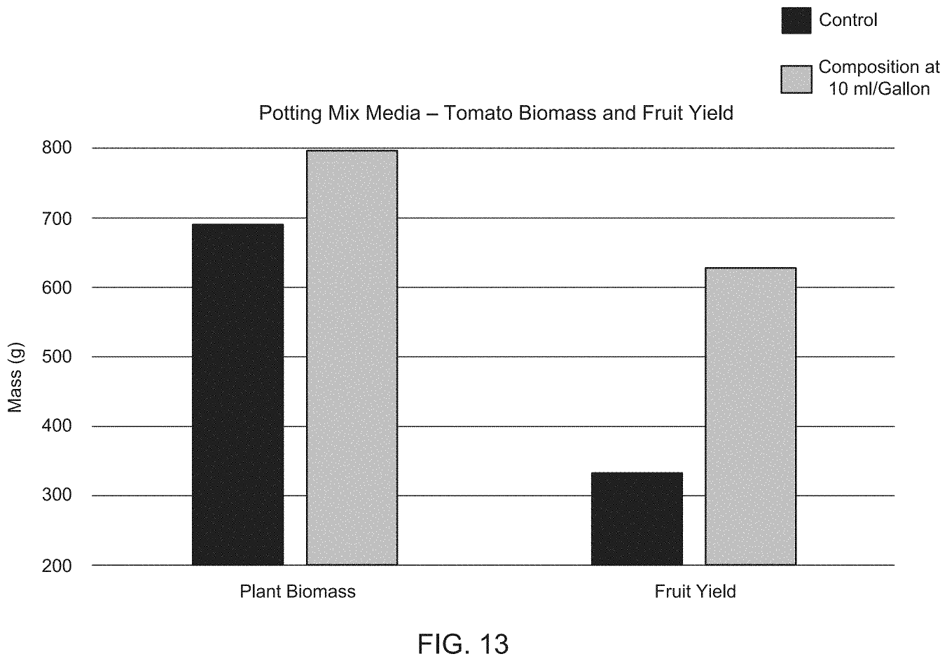

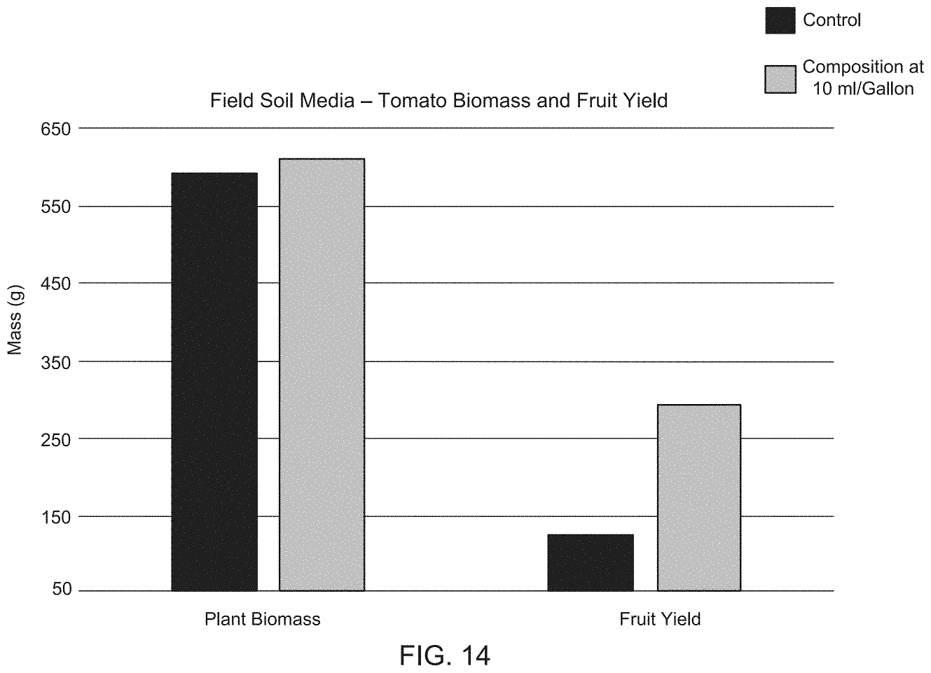

As can be seen in in FIGS. 13 and 14, the total biomass in the tomato was significantly greater in the tomato plants that were treated with the composition. Indeed, the tomato yield in the treated plants was almost twice the weight of the control regardless of the potting media.

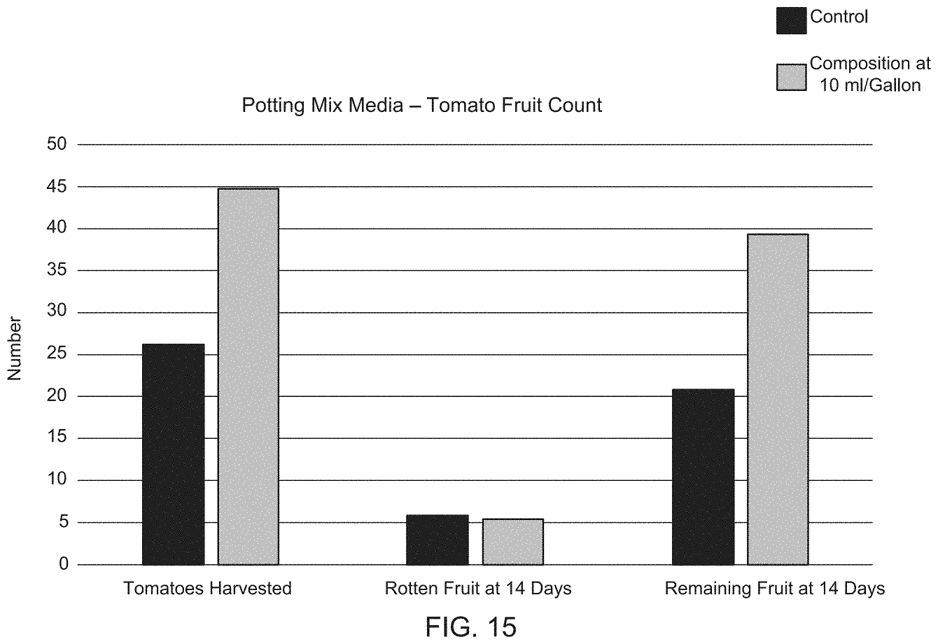

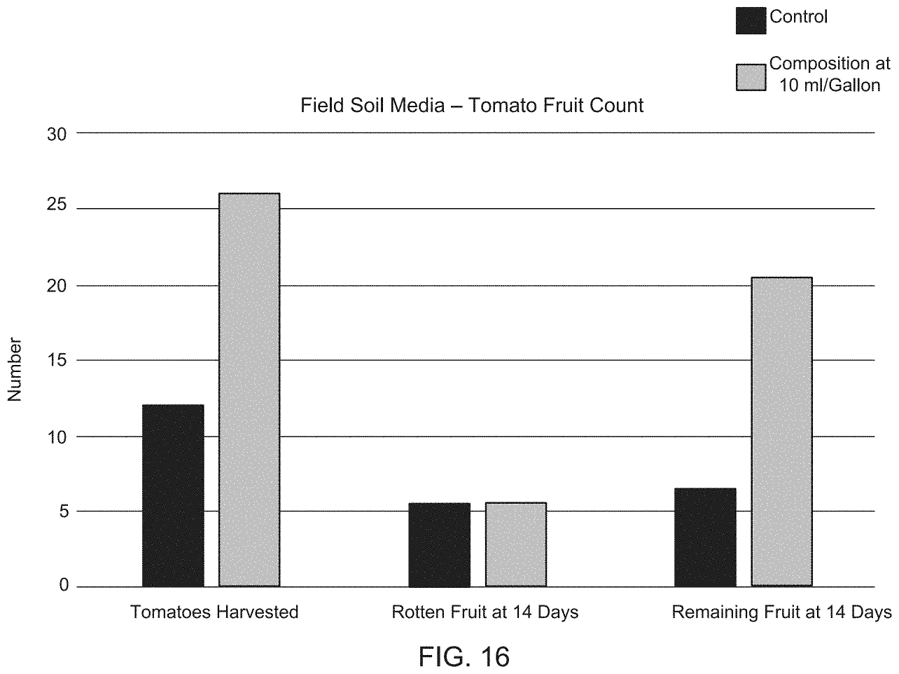

Referring now to FIGS. 15 and 16, even though the treated plants yielded more tomatoes the rate in which the fruit would rot was almost half the rate of the untreated control regardless of the potting media.

Thus, the disclosure in one embodiment encompasses compositions including one or more plant-derived protein hydrolysates, a surfactant (e.g., one or more siloxane copolymers or SWIFT-WET), the supramolecular host or guest chemical, and water. In a preferred embodiment, the protein hydrolysate is a yeast extract.

Although only a few exemplary embodiments have been described in detail above, those of ordinary skill in the art will readily appreciate that many other modifications are possible in the exemplary embodiments without materially departing from the novel teachings and advantages of the present invention. Accordingly, all such modifications are intended to be included within the scope of the present invention as defined in the following claims.

1. An agricultural composition consisting essentially of:
a biological compound, wherein the biological compound is selected from a yeast extract or other plant-derived protein hydrolysate;
a surfactant;
a supramolecular host or guest chemical configured to engage in host-guest chemistry with the biological compound, the surfactant, or both; and
a solvent.

2. The composition of claim 1, wherein the surfactant comprises a non-ionic or ionic surfactant, and the solvent comprises water.

3. The composition of claim 1, further consisting essentially of one more additives selected from a pH buffer, a defoamer, macronutrients, micronutrients, a plant growth regulator, a crop protectant, a drift control agent, a sticker, a spreader, a tank cleaner, or a combination thereof.

4. (canceled)

5. The composition of claim 1, wherein the composition is stable under temperatures of 40° F. to 140° F. for at least 6 weeks.

6. The composition of claim 1, wherein the biological compound is present in an amount of about 10 percent to about 50 percent by weight of the composition.

7. The composition of claim 1, wherein the surfactant is present in an amount of about 0.1 percent to about 50 percent by weight of the composition.

8. The composition of claim 1, wherein the supramolecular host chemical or supramolecular guest chemical is present in an amount of about 1 percent to about 90 percent by weight of the composition, about 50 percent to about 85 percent by weight of the composition.

9. The composition of claim 1, wherein the supramolecular host chemical is present and comprises a cavitand, a cryptand, a rotaxane, a catenane, a nanostructure, or any combination thereof, or the supramolecular guest chemical is present and comprises cyanuric acid, melamine, or any combination thereof, or both a supramolecular host and guest chemical are present.

10. The composition of claim 1, wherein the supramolecular host chemical is present and comprises a nanostructure having a charge, magnetic properties, or both.

11. A method of preparing the composition of claim 1, which method comprises:
mixing components of the composition in the following order:
(1) the solvent,
(2) the biological compound, and
(3) the surfactant,
to form a mixture; and
adding (4) the supramolecular host or guest chemical to the mixture to form the composition.

12. A method of treating a plant to improve nutrient assimilation, water uptake, yield, shelf life, or vigor, comprising:
applying a composition to the plant in an agriculturally effective amount, the composition consisting essentially of:
a biological compound, wherein the biological compound is selected from a yeast extract or other plant-derived protein hydrolysate;
a surfactant;
a supramolecular host or guest chemical configured to engage in host-guest chemistry with the biological compound, the surfactant, or both; and
a solvent.

13. The method of claim 12, wherein the composition is applied at a concentration of 0.1 mL to 2 mL of the composition per gallon of carrier fluid or 90 mL to 150 mL of the composition per gallon of carrier fluid.

14. The method of claim 12, wherein the composition is applied by injection, drip, broadcast, banding, soil drench, foliar, fertigation, or aerial methods, or a combination thereof.

15. The method of claim 12, wherein the surfactant is selected to comprise a non-ionic or ionic surfactant, and the solvent is selected to comprise water.

16. The method of claim 15, wherein the composition further consists essentially of one or more additives selected from a pH buffer, a defoamer, macronutrients, micronutrients, a plant growth regulator, a crop protectant, a drift control agent, a sticker, a spreader, a tank cleaner, or a combination thereof.

17. The method of claim 12, wherein the yeast extract comprises the Sacchoromyces genus of yeast.

18. The method of claim 12, wherein the biological compound is present in an amount of about 10 percent to about 50 percent by weight of the composition.

19. The method of claim 12, wherein the surfactant is present in an amount of about 0.1 percent to about 50 percent by weight of the composition.

20. The method of claim 12, wherein the supramolecular host chemical or supramolecular guest chemical is present in an amount of about 1 percent to about 90 percent by weight of the composition.

21. The method of claim 12, wherein the supramolecular host chemical is present and comprises a cavitand, a cryptand, a rotaxane, a catenane, a nanostructure, or any combination thereof, or the supramolecular guest chemical is present and comprises cyanuric acid, melamine, or any combination thereof; or both a supramolecular host and guest chemical are present.

22. The method of claim 12, wherein the supramolecular host chemical is present and comprises a nanostructure having a charge, magnetic properties, or both.

23. The method of claims 12, which further comprises mixing the composition with a fertilizer before applying the composition to the plant.

24. The method of claim 12, which further comprises increasing a plant weight, a yield, a shelf life, or a nutrient uptake in the plant compared to a plant that did not receive the agriculturally effective amount of the composition.

25. The method of claim 24, wherein there is an increase in the plant weight that is about two times an increase in plant weight in the plant that did not receive the agriculturally effective amount of the composition.

26. The method of claim 24, wherein there is an increased nutrient uptake of nickel, copper, zinc, manganese, iron, molybdenum, boron, calcium, sulfur, phosphorus, magnesium, calcium, potassium, nitrogen, carbon, or a combination thereof.
